(19) United States
(12) Patent Application Publication
(10) Pub. No.: US 2004/0138772 A1
(43) Pub. Date: Jul. 15, 2004

(54) Automated machine component design tool

(75) Inventors: Priyatosh Barman, Naperville, IL (US); Jose C. Lopez Dominguez, Bloomingdale, IL (US)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/743,755

(22) Filed: Dec. 24, 2003

Related U.S. Application Data
(60) Provisional application No. 60/436,464, filed on Dec. 27, 2002.

(51) Int. Cl. G06F 19/00

(52) U.S. Cl. 700/97; 705/400

(57) ABSTRACT

A system and method for designing a machine component is provided. A plurality of requirements associated with the machine component are established. A component layout is automatically established in response to the plurality of requirements. The component layout is analyzed to determine whether the component layout meets a predetermined performance threshold. A final component design is established when the component layout meets the predetermined performance threshold. The system and method may further compare the component layout with a set of information related to existing machine components and identify an existing machine component that has a similar layout to the component layout. In addition, the system and method may determine the costs associated with the component layout and identify changes in the component layout to reduce the costs associated with the component layout. In addition, the method provides the opportunity to capture and implement design or analysis method improvements.

This application claims the benefit of the filing date of U.S. Provisional Application No. 60/436,464, filed Dec. 27, 2002, incorporated herein by reference.

### TECHNICAL FIELD

The present invention is directed to an automated design tool and, more particularly, to an automated tool for designing a machine component.

### BACKGROUND

Work machines, such as, for example, excavators, backhoes, and wheel loaders, typically include several different systems that work together to accomplish a particular task. For example, a work machine may include a hydraulic system and a work implement linkage system. The hydraulic system may provide the power required to move a work implement to perform a task, such as, for example, moving a load of earth or debris from a first location to a second location.

Different work machines may be designed to meet different operational requirements. For example, some work machines may be adapted to move relatively small loads over relatively small distances, whereas other work machines may be adapted to move relatively large loads over relatively large distances. The varying operational requirements of each work machine may result in each work machine having, for example, different load moving capacities, ranges of motion, overall size, and travel capability.

Each component within each system on a particular work machine is typically designed to meet the operational requirements for the particular work machine. For example, a hydraulic system of a work machine may be required to provide a certain amount of lifting power and a certain lifting range to a work implement. Accordingly, the fluid cylinders within the hydraulic system that are connected to the work implement should be designed to generate the required lifting power and range without failing when the work machine performs a particular task.

A typical design process for a machine component, such as a fluid cylinder, usually includes several steps. The first step in the design process includes identifying the design requirements for the particular component. An initial component layout may be established based on the design requirements. The structure of the initial component layout may then be analyzed to determine whether the layout meets the operational requirements of the work machine, as well as fitting within the overall design scheme for the work machine. If the analysis reveals that the initial layout does not fit the operational requirements, the component layout is revised to correct the problem.

Each step of the typical design process is usually performed by a different person that has a different area of expertise. For example, a design specialist may generate the initial component layout. The initial component layout may then be transferred to one or more specialists who can then analyze the design to assess the validity of the design against operational requirements. If design changes are required, the component layout is returned to the responsible party. When the design changes are effected, the layout is returned to the specialists to restart the cycle.

The transfer of the component layout between different groups and/or different individuals may result in delays in the design process. In addition, these transfers may also result in a lack of conformity in the design process of different components. Thus, the design of one machine component may be more expensive or performed differently than the design process for another machine component.

In addition, this typical design process may not take advantage of the presence of existing components that may meet the current operating conditions with little or no changes. For example, an existing fluid cylinder may be adapted to meet the design requirements for a new fluid cylinder with a small change, such as, for example, changing the configuration of a connection between the fluid cylinder and a work implement. If the existing component is not identified, the expensive design process may be unnecessarily repeated.

The system and method of the present invention solves one or more of the problems set forth above.

### SUMMARY OF THE INVENTION

In one aspect, the present disclosure is directed to a method of designing a machine component. A plurality of requirements associated with the machine component are established. A component layout is automatically established in response to the plurality of requirements. The component layout is analyzed to determine whether the component layout meets a predetermined performance threshold. A final component design is established when the component layout meets the predetermined performance threshold.

In another aspect, the present disclosure is directed to a method of designing a machine component. A plurality of requirements associated with the machine component are established. The plurality of requirements are compared with a set of information related to existing machine components in an automated manner. A final design is established in response to said comparison.

In yet another aspect the present disclosure is directed to a method of designing a machine component. A plurality of requirements associated with the machine component are established. A component layout is established in response to the plurality of requirements. The costs associated with the component layout are determined. Changes in the component layout are identified to reduce the costs associated with the component layout.

### BRIEF DESCRIPTION OF THE DRAWINGS

FIG. 1 is a block diagram illustrating a system for automatically designing a machine component in accordance with an exemplary embodiment of the present invention;

FIG. 2 is cross-sectional view of an exemplary embodiment of a fluid cylinder; and

FIG. 3 is a flowchart illustrating an exemplary method of designing a machine component in accordance with the present invention.

### DETAILED DESCRIPTION

Reference will now be made in detail to embodiments of the present invention, examples of which are illustrated in the accompanying drawings. Wherever possible, the same reference numbers will be used throughout the drawings to refer to the same or like parts.

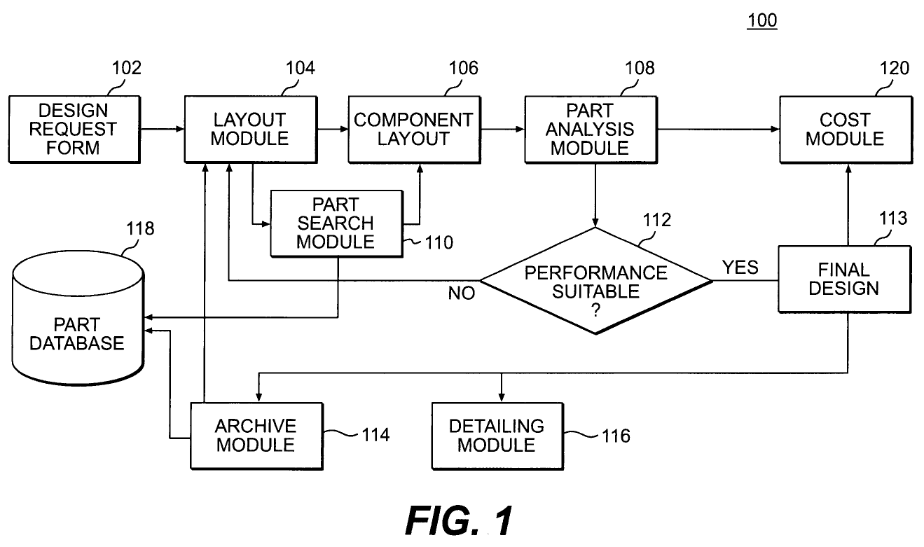

An exemplary embodiment of a system 100 for designing a machine component is illustrated in FIG. 1. For the purposes of the present disclosure, a machine may be considered any type of mechanized equipment. For example, a machine may be an excavator, a backhoe, a wheel loader, a garbage truck, or automated production equipment.

One or more aspects of system 100 may be automated. For example, the entire system 100 may be automated and initiated by an input from a user. Alternatively, one or more aspects of system 100 may require manual input from one or more individuals, such as, for example, a design specialist, an analysis specialists, and/or a work flow manager. Accordingly, system 100 may be contained in a single microprocessor. Alternatively, system 100 may be distributed across multiple microprocessors and connected through a network such as, for example, a local area network, a wide area network, the Internet, or another appropriate communications system. It should be noted that any or all of the modules, databases, or forms of the system 100 may be in hard copy form such as, for example, paper or alternatively, electronic form such as, for example, a web page or other computer-based input device. Any electronic form may include a graphical user interface such as, for example, a HTML-based web page or pages.

System 100 includes a design request form 102. Design request form 102 allows a user to input one or more design requirements regarding, inter alia, the shape and operational parameters of a machine component. For example, design request form 102 may allow a user to enter information such as expected load requirements, size requirements, weight requirements, and/or life cycle requirements. As stated above, design request form 102 may be in hard copy form or in an electronic form. One skilled in the art will recognize that design request form 102 may be any device or procedure that allows an individual, such as, for example, a product manager, a design engineer, or a test engineer, to specify one or more design requirements for a work component.

An electronic version of design request form 102 may include a graphical user interface, such as, for example, a HTML-based web page or pages. Design request form 102 may include a series of input fields that allow the user to define the design requirements for the particular machine component. The input fields may be any commonly used input device, such as for example, drop down lists, radio buttons, select buttons, or free text fields.

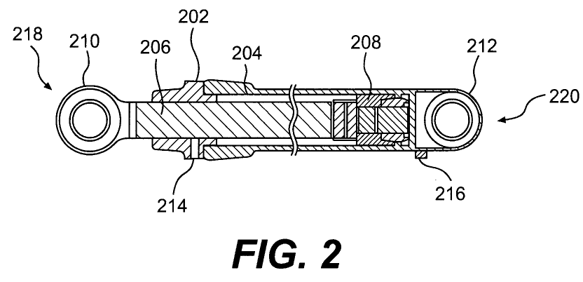

Design request form 102 may allow a user to enter the design requirements or parameters for any type of machine component. For example, a user may enter a plurality of design requirements related to a fluid cylinder for use in a hydraulic system of a work machine. An exemplary embodiment of a fluid cylinder 200 is illustrated in FIG. 2.

As shown, a fluid cylinder 200 may include a housing 202 that has a rod end 218 and a head end 220. Housing 202 defines a bore 204 that slidably receives a rod 206 and a connected piston 208. A rod end cap 210 is engaged with rod end 218 of housing 202. A head end cap 212 is engaged with head end 220 of housing 202. Housing 202 also defines a rod end port 214 that allows fluid to be directed into bore 204 on the rod side of piston 208. Housing 202 also defines a head end port 216 that allows fluid to be directed into bore 204 on the head end side of piston 208.

As one skilled in the art will recognize, the design requirements of fluid cylinder 200 will vary depending upon the requirements and limitations for the work machine on which fluid cylinder 200 will be used. For example, the load lifting, range of movement, weight, and size requirements of the work machine may impact the final design of fluid cylinder 200. Design request form 102 may be adapted to allow a user to enter all relevant design requirement information related to fluid cylinder 200.

When designing fluid cylinder 200, the user may be required to enter relevant design requirements, such as, for example, one or more of a diameter of bore 204, a diameter of rod 206, a stroke length of rod 206, a configuration of head end cap 212, a configuration of rod end cap 210, a head end cap 212 pin diameter, a rod end cap 210 pin diameter, a head end port 216 type, a head end port 216 size, a head end port 216 orientation, a rod end port 214 type, a rod end 214 port size, a rod end port 214 orientation, an eye configuration, and a piston joint configuration. One skilled in the art will recognize that design request form 102 may be adapted to capture additional information about the particular machine component, such as general information about the fluid cylinder 200 including, for example, a request form submission date, a serial number, a revision number, an identity of the submitting user, a cylinder function, a sales model number, an engineering model number, the number of cylinders required for each work machine, a location of the cylinder on the work machine, references to similar parts, differences from the similar parts, shipping instructions, work machine build locations, and production dates.

Design request form 102 may be adapted to validate the information inputted by the user. For example, design request form 102 may ensure that the user has entered enough information to allow the design process to continue. In addition, design request form 102 may compare each entered design requirement to expected values. If the entered value differs from the expected values, the user may be prompted to correct the error or confirm that the entered value is correct.

Design request form 102 may also be adapted to provide instructions or clarifications to the user to assist in the entry of the design requirements. For example, design request form 102 may include drawings or figures that illustrate an exemplary fluid cylinder 200 to indicate the required design requirements. Design request form 102 may also include help screens or other similar functions to further assist the user in entering the design requirements.

As shown in FIG. 1, system 100 also includes a layout module 104. Layout module 104 receives the design requirements entered on design request form 102. If design request form 102 is automated, the design requirements may be automatically transferred to layout module 104. Alternatively, a second user may input the design requirements from a hard copy design request form 102 into layout module 104.

Layout module 104 generates an initial component layout 106. Layout module 104 may automatically generate component layout 106 based on the entered design requirements. If additional information is required to complete component layout 106, layout module 104 may prompt a user to enter the required information. In the case of fluid cylinder 200, the user may be prompted to enter additional information, such as, for example, the desired configuration of a rod end cap, a head end cap, and a piston joint. One skilled in the art will recognize that layout module 104 may be adapted to receive additional information about fluid cylinder 200, such as, for example, specific size information regarding any of the particular parts. In one exemplary embodiment, layout module 104 may allow a user to access previously developed designs so the user may view, review, compare, browse, and/or search the previously developed designs, as is described further below. Layout module 104 may also include help screens and/or graphical representations of the design parameters to be entered.

System 100 may also include a part database 118 that stores a set of information related to the design and layout of existing machine components.

The information stored in part database 118 may be searched by part number or any other parameter, such as, for example, part type or machine type. One skilled in the art will recognize part database 118 may be any commonly used computer readable data storage structure.

System 100 may also include a part search module 110. Part search module may be adapted to search part database 118 for existing components that are similar to the component currently being designed. Part search module 110 may search part database 118 to compare the current design requirements with existing design requirements to identify similar components.

The degree of similarity between an existing component and the current layout may vary from application to application and/or from component type to component type. For example, an existing component may be sufficiently similar to the current component layout when a certain number of design parameters of the existing component are within a pre-determined range of the corresponding design parameter of the current layout. Alternatively, one or more design parameters of the current component layout may be prioritized as essential to the layout. In this case, an existing component may be identified as similar when the corresponding design parameters of the existing component are within a certain tolerance of the prioritized design parameters.

Layout module 104 may be adapted to interface with part search module 110 to initiate a part search. If part search module 110 determines that an existing component is sufficiently similar to the component being designed, part search module 110 may notify the user of the potential match. If this existing component meets all the necessary requirements, the user may decide to use the layout of the existing component on the new work machine instead of designing a new component layout.

System 100 also includes a part analysis module 108. Part analysis module 108 may perform any analysis on component layout 106 to determine whether the component will meet the overall design requirements for the work machine. For example, the component may be required to meet certain life, reliability, durability, stress, and/or strain requirements. Part analysis module 108 may be adapted to perform one or more simulations, such as, for example, a finite element analysis, of component layout 106 to determine whether the component is capable of meeting the necessary requirements. One skilled in the art will recognize that part analysis module 108 may perform any type of design or structural analysis.

Part analysis module 108 may be adapted to change component layout 106 to enhance the performance of the particular component. Part analysis module 108 may be adapted to analyze many different design iterations of the particular component to identify the best possible configuration of component layout 106. Part analysis module 108 may provide a series of results to a structural analyst to help in interpreting results and analyzing any radical or abnormal component layouts 106.

System 100 may also include a checkpoint 112 at the completion of part analysis module 108. At the checkpoint 112, system 100 may determine whether the component layout 106 is suitable for the particular application. For example, system 100 may verify that the part design will meet a minimum component life expectancy and/or work machine space requirements. If component layout 106 meets all necessary tests, component layout 106 may become a final component design 113.

System 100 may also include an archive module 114. Archive module 114 may save final design 113 to part database 118. In this manner, part database may be used as a knowledge vault for future designers. In addition, part database 118 allows minor changes to existing machine components cylinders to be processed and analyzed faster. In one exemplary embodiment, system 100 is configured to allow a user to access the archive module 114 to access and review saved final designs. In the electronic form embodiment of system 100, a radio button may be provided at any module throughout the system 100 that would allow the user to view previously developed designs. In FIG. 1, the layout module 104 may include a selectable radio button that would allow a user to access the archive module 114 to view, review, compare, browse, and/or search previously developed designs.

System 100 may also include a detailing module 116. Detailing module 116 may process the final component design 113 for production. Detailing module 116 may provide production or manufacturing engineers with any information required to build the designed part by the required dates. For example, detailing module 116 may generate the drawings required to make the particular machine component.

System 100 may also include a cost module 120. Cost module 120 may be adapted to analyze the part design from a cost perspective. Cost module may analyze either the component layout 106 or the final component design 113.

If cost module 120 determines that the cost of the proposed design is excessive, cost module 120 may suggest an alternative design. For example, if the proposed design of a particular fluid cylinder 200 calls for a non-standard bore diameter, cost module 120 may suggest that the component layout 106 be modified to use a standard bore size. One skilled in the art will recognize that cost savings may be associated with using standard or commonly stocked parts or materials, instead of parts or materials requiring specialized machining or manufacturing.

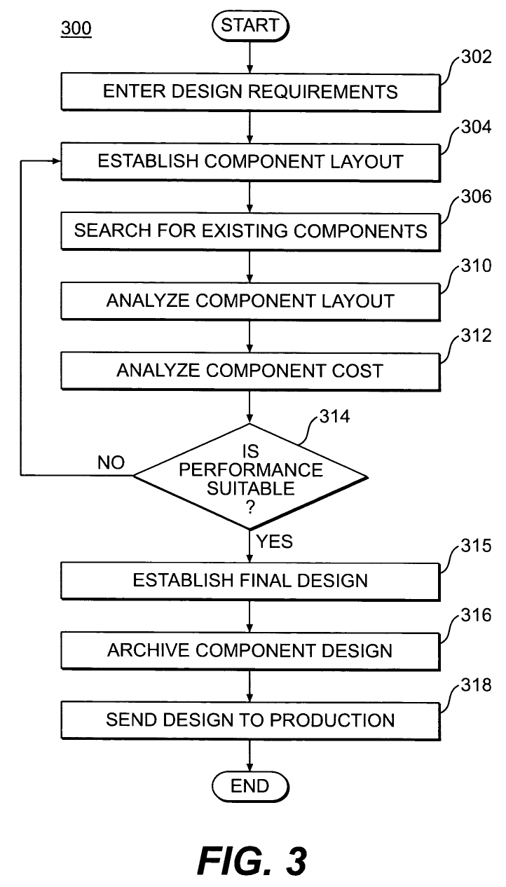

The flowchart of FIG. 3, illustrates an exemplary method 300 of designing a machine component. A user may establish a plurality of design requirements associated with the machine component. (Step 302). The design requirements may, for example, be entered into an electronic design request form 102.

Based on the entered design requirements, system 100 may establish a component layout. (Step 304). Establishing the component layout may be done automatically by a layout module 104. If necessary, a user may enter additional information regarding the particular component to complete the component layout. The user may also be allowed to access previously developed designs archived by system 100 for review or other purpose.

The component layout may then be compared with existing components. (Step 306). For example, part search module 110 may compare the present component layout with existing component layouts stored in part database 118. If a potential part match is identified, the user may be notified and allowed to select the existing part or to continue with the previously established component layout.

The component layout is then analyzed. (Step 310) Part analysis module 108 may analyze the component layout to determine whether the component will meet expected performance criteria. The analysis may include, for example, a finite element analysis.

The costs associated with making the component may also be analyzed. (Step 312). This analysis may include estimating the costs associated with manufacturing each part in the component. If the cost is excessive, system 100 may identify potential design changes to reduce the cost. For example, changing a diameter or a length requirement may reduce the amount of machining associated with making a part, and thereby reduce the total cost of the component.

The performance of the component layout is then analyzed to determine if the performance is suitable. (Step 314). This analysis may ensure that the component layout will meet other criteria, such as, for example, a certain life cycle. If the component layout does not meet a predetermined performance threshold, the design and the performance issue may be returned to the user, or to layout module 104, for correction. The predetermined performance threshold may be a performance threshold established at an initial inception of the design, or alternatively, may be a new or different performance threshold of an existing design input into the system 100. For example, in one embodiment, a performance requirement of an existing component is changed, and the present system 100 may be used to re-design the component to meet the new threshold by inputting the performance requirement into the system 100 as a predetermined performance threshold. The component layout may be returned to the user or layout module 104 with supporting information, such as, for example, the reason that the layout did not meet the predetermined performance threshold and/or a recommended design change that may allow the component to meet the predetermined performance threshold. The user, or layout module 104, may then adjust the component layout to correct the problem and resume the design process.

If the component layout meets the performance threshold, a final component design 113 may be established. (Step 315) The final component design may then be archived in part database 118. (Step 316). By archiving the final component design 113, system 100 allows future designers to take advantage of the design work performed in connection with the design of each component.

The final component design may also be detailed and sent to production. (Step 318). The detailing step may include, for example, generating engineering drawings and parts list. This information may be transmitted to a production facility so that the final component design may be built.

Industrial Applicability

As will be apparent from the foregoing disclosure, the system and method of the present invention may be used to automate one or more aspects of the design and analysis process for a machine component. While the present disclosure has been described in connection with the design and analysis of a fluid cylinder, one skilled in the art will recognize that the described system and method may be used in the design and analysis process for any machine component. For example, the system and method of the present invention may be used in the design of another fluid system component such as a pump, a valve, or a tank; a work implement system component, such as a boom, a stick, or a ground engaging tool; a work implement linkage component; a work machine drive train component; or any other appropriate machine component.

The system and method of the present invention may reduce the time and expense associated with the design of a work component. By automating one or more of the design steps, the lag time associated with transferring work between different specialists may be reduced. In addition, the disclosed system ensures that each component follows the same steps in the design process. This may result in a decrease in overall design time, as well as a decrease in design cost.

The disclosed system also uses information about existing components stored in a database. The database of existing components may be searched at an early stage in the design process to identify similar existing components. If the existing component meets the entered design requirements, the existing component may be used instead of continuing on with the design process. In addition, quick changes may be made to the existing component to meet the current design requirements.

In addition, the disclosed system and method may control the costs associated with manufacture of the particular component. The component layout may be analyzed to determine if any particular design aspect significantly raises the cost of the component. If so, the system may identify an alternative and cheaper layout to reduce the cost of manufacturing the component.

It will be apparent to those skilled in the art that various modifications and variations can be made in the disclosed system and method without departing from the scope of the invention. For example, additional modules or features may be added to the system 100 without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A method of designing a machine component, comprising:
establishing a plurality of requirements associated with the machine component;
automatically establishing a component layout in response to the plurality of requirements;
analyzing the component layout to determine whether the component layout meets a predetermined performance threshold; and
establishing a final component design when the component layout meets the predetermined performance threshold.

2. The method of claim 1, further including modifying the component layout when the component layout does not meet the predetermined performance threshold.

3. The method of claim 1, further including:
comparing the component layout with a set of information related to existing machine components; and
identifying an existing machine component having a similar layout to component layout.

4. The method of claim 1, wherein the analysis of the component layout analysis includes a finite element analysis.

5. The method of claim 1, wherein the predetermined performance threshold includes a minimum component life expectancy.

6. The method of claim 1, wherein machine component is a fluid cylinder and the plurality of requirements includes at least one of a bore diameter, a rod diameter, a stroke length, a head end pin diameter, a rod end pin diameter, a head end port type, a head end port size, a head end port orientation, a rod end port type, a rod end port size, and a rod end port orientation.

7. The method of claim 1, further including archiving the final component design in a part database.

8. The method of claim 7, further including reviewing a previously stored final component design.

9. The method of claim 1, further including determining the costs associated with the final component design.

10. The method of claim 9, further including identifying design changes to reduce the costs associated with final component design.

11. A system for designing a machine component, comprising:
an input device adapted to receive a plurality of requirements associated with a machine component; and
a processor adapted to establish a component layout in response to the plurality of requirements, to analyze the component layout to determine whether the component layout meets a predetermined performance threshold, and to establish a final component design when the component layout meets the predetermined performance threshold.

12. The system of claim 11, further including a storage device adapted to store a set of information related to a plurality of existing machine components.

13. The system of claim 11, wherein the processor is adapted to perform a finite element analysis on the component layout.

14. The system of claim 11, wherein the input device includes an electronic design requirements form including input fields adapted to receive the plurality of requirements.

15. The system of claim 14, wherein machine component is a fluid cylinder and the plurality of requirements includes at least one of a bore diameter, a rod diameter, a stroke length, a head end pin diameter, a rod end pin diameter, a head end port type, a head end port size, a head end port orientation, a rod end port type, a rod end port size, and a rod end port orientation.

16. The system of claim 11, wherein the processor is adapted to determine the costs associated with the final component design and to identify design changes to reduce the costs associated with the final component design.

17. A method of designing a machine component, comprising:
establishing a plurality of requirements associated with the machine component;
comparing the plurality of requirements with a set of information related to existing machine components in an automated manner; and
establishing a component layout design in response to said comparison.

18. The method of claim 17, further including identifying an existing machine component having a layout including at least one of the plurality of requirements.

19. The method of claim 17, further including:
analyzing the component layout to determine whether the component layout meets a predetermined performance threshold; and
establishing a final component design when the component layout meets the predetermined performance threshold.

20. The method of claim 19, further including modifying the component layout when the component layout does not meet the predetermined performance threshold.

21. The method of claim 19, further including archiving the final component design in a part database.

22. The method of claim 17, wherein the machine component is a fluid cylinder and the plurality of requirements includes at least one of a bore diameter, a rod diameter, a stroke length, a head end pin diameter, a rod end pin diameter, a head end port type, a head end port size, a head end port orientation, a rod end port type, a rod end port size, and a rod end port orientation.

23. The method of claim 17, further including determining the costs associated with the final component design.

24. The method of claim 23, further including identifying design changes to reduce the costs associated with final component design.

25. A system for designing a machine component, comprising:
an input device adapted to receive a plurality of requirements associated with a machine component; and
a processor adapted to establish a component layout in response to the plurality of requirements, to compare the component layout with a set of information related to existing machine components, and to identify an existing machine component having a layout similar to the established component layout.

26. The system of claim 25, wherein the processor is adapted to analyze the component layout to determine whether the component layout meets a predetermined performance threshold and to establish a final component design when the component layout meets the predetermined performance threshold.

27. The system of claim 25, further including a storage device adapted to store a set of information related to a plurality of existing machine components.

28. A method of designing a machine component, comprising:
establishing a plurality of requirements associated with the machine component;
establishing a component layout in response to the plurality of requirements;
determining the costs associated with the component layout; and
identifying changes in the component layout to reduce the costs associated with the component layout.

29. The method of claim 28, further including:
comparing the component layout with a set of information related to existing machine components; and
identifying an existing machine component having a layout similar to the established component layout.

30. The method of claim 28, further including:
analyzing the component layout to determine whether the component layout meets a predetermined performance threshold; and
establishing a final component design when the component layout meets the predetermined performance threshold.

31. The method of claim 30, further including modifying the component layout when the component layout does not meet the predetermined performance threshold.

32. The method of claim 28, further including archiving the final component design in a part database.

33. A system for designing a machine component, comprising:
an input device adapted to receive a plurality of requirements associated with a machine component; and
a processor adapted to establish a component layout in response to the plurality of requirements, to determine the costs associated with the component layout, and to identify changes in the component layout to reduce the costs associated with the component layout.

34. The system of claim 33, further including a storage device adapted to store a set of information related to a plurality of existing machine components.

35. The system of claim 34, wherein the processor is adapted to compare the component layout with the set of information related to existing machine components and to identify an existing machine component having a layout similar to the component layout.

36. The system of claim 33, wherein the processor is adapted to analyze the component layout to determine whether the component layout meets a predetermined performance threshold and to establish a final component design when the component layout meets the predetermined performance threshold.
